(19) United States
(12) Patent Application Publication
(10) Pub. No.: US 2014/0358423 A1
(43) Pub. Date: Dec. 4, 2014

(54) METHOD AND APPARATUS FOR AUTOMATICALLY WARNING DRIVER TO TAKE A BREAK

(71) Applicant: SONY CORPORATION, Tokyo (JP)

(72) Inventors: David George Thiele, San Diego, CA (US); Marvin DeMerchant, San Diego, CA (US); Steven Friedlander, San Diego, CA (US)

(73) Assignee: SONY CORPORATION, Tokyo (JP)

(21) Appl. No.: 13/904,253

(22) Filed: May 29, 2013

(51) Int. Cl. G01C 21/36; B60W 50/14

(52) U.S. Cl. CPC G01C 21/3679; B60W 50/14; B60W 2050/146; B60W 2040/0827
USPC 701/423

(57) ABSTRACT

A driver caution threshold that varies by time of day and/or by driver activity load factor is compared a vehicle driver's activity. Responsive to a determination that vehicle driver's activity violates the driver caution threshold, a prompt to take a break and/or directions to a nearby restaurant are presented.

### I. FIELD OF THE INVENTION

The present application relates generally to automatically warning vehicle drivers to take a break.

### II. BACKGROUND OF THE INVENTION

Travelers that drive long distances, including commercial drivers, are prone to experience fatigue and consequential loss of concentration and falling asleep during long periods between rest breaks. Drivers may be unaware of driving parameters, such as distance or time traveled, and as a result continue driving beyond the period in which they can maintain safe mental status and alertness. The present application aims to avoid dangerous driving by collecting data from the vehicle and external sources and notifying the driver that a rest break is recommended, e.g. via a smartphone application “ding,” when a preset threshold has been reached.

### SUMMARY OF THE INVENTION

An apparatus includes a computer readable storage medium that is not a carrier wave and that is accessible to a client processor of a client device and bears instructions executable by the client processor. Upon execution, the instructions on the storage medium configure the client processor to establish communication with a vehicle processor and determine a driver activity parameter of a driver of a vehicle associated with the vehicle processor. The client processor is responsive to a determination that the driver activity parameter satisfies a threshold and subsequently presents on a display in the vehicle a prompt for a driver of the vehicle to stop for a break. Recommendation of a restaurant along the route with directions to the restaurant is also/alternatively presented on a display in the vehicle.

In response to a determination that the driver activity parameter satisfies a threshold, the client processor may execute instructions that can direct the client processor to present on a display in the vehicle a prompt for a driver of the vehicle to stop for a break and/or present a recommendation of a restaurant along with directions to the restaurant. The threshold established by the client processor executing the instructions on the storage media may be established at least in part based on time of day such that a first threshold is used at a first time of day and a second threshold is used at a second time of day.

The threshold may be established by the client processor also at least in part based on driver activity load factor such that a first threshold is used for a first driver activity load factor and a second threshold is used for a second driver activity load factor. The first and second driver activity load factors may include one or more of vehicle turns, vehicle brake applications, vehicle speed, and/or vehicle gear shifts.

The driver activity parameter may be established by the client processor executing instructions on the storage media based on a variety of factors. These factors can include, but are not limited to: a number of vehicle turns (the threshold being a threshold number of vehicle turns), a number brake applications by the driver (the threshold being a threshold number of brake applications), a speed of the vehicle (the threshold being a threshold average or top speed for a threshold period), a number of gear shifts of the vehicle by the driver (the threshold being a threshold number of gear shifts), and/or a distance traveled (the threshold being a threshold distance).

In another aspect, an apparatus includes at least one computer readable storage medium that is not a carrier wave and that is accessible to a processor. The storage medium bears instructions that, when executed by the client processor, configure the processor to execute a method including determination of a driver activity parameter of a driver of a vehicle associated with the vehicle processor. The processor is responsive to a determination that the driver activity parameter satisfies a threshold and subsequently presents on a display in the vehicle a prompt for a driver of the vehicle to stop for a break. The processor also/alternatively presents on a display in the vehicle a recommendation of a restaurant along with directions to the restaurant.

In another aspect, a method includes establishment of a driver caution threshold that varies by time of day and/or by driver activity load factor. A vehicle driver's activity is compared to the driver caution threshold. Determination that a vehicle driver's activity violates the driver caution threshold results in presentation of a prompt to take a break and/or presentation of directions to a nearby restaurant. Otherwise, determination that vehicle driver's activity does not violate the driver caution threshold results in no presentation of a prompt to take a break and/or no presentation of directions to a nearby restaurant.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system according to present principles;

FIG. 2 is a flow chart of example overall logic;

FIG. 3 is a flow chart of example threshold variation logic based on time of day; and

FIG. 4 is a flow chart of example threshold variation logic based on driver activity load factor.

### DETAILED DESCRIPTION OF THE PREFERRED EMBODIMENT

Disclosed are methods, apparatus, and systems for computer based user information. A system herein may include server and client components, connected over a network such that data may be exchanged between the client and server components. The client components may include one or more computing devices. These may include personal computers, laptops, tablet computers, and other mobile devices including smart phones. These client devices may operate with a variety of operating environments. For example, some of the client computers may be running Microsoft Windows® operating system. Other client devices may be running one or more derivatives of the Unix operating system, or operating systems produced by Apple® Computer, such as the IOS® operating system, or the Android® operating system, produced by Google®. While examples of client device configurations are provided, these are only examples and are not meant to be limiting. These operating environments may also include one or more browsing programs, such as Microsoft Internet Explorer®, Firefox, Google Chrome®, or one of the other many browser programs known in the art. The browsing programs on the client devices may be used to access web applications hosted by the server components discussed below.

Server components may include one or more computer servers executing instructions that configure the servers to receive and transmit data over the network. For example, in some implementations, the client and server components may be connected over the Internet. In other implementations, the client and server components may be connected over a local intranet, such as an intranet within a school or a school district. In other implementations a virtual private network may be implemented between the client components and the server components. This virtual private network may then also be implemented over the interne or an intranet.

The data produced by the servers may be received by the client devices discussed above. The client devices may also generate network data that is received by the servers. The server components may also include load balancers, firewalls, caches, and proxies, and other network infrastructure known in the art for implementing a reliable and secure web site infrastructure. One or more server components may form an apparatus that implement methods of providing a secure community to one or more members. The methods may be implemented by software instructions executing on processors included in the server components. These methods may utilize one or more of the user interface examples provided below in the appendix.

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as the AMD® Athlon® II or Phenom® II processor, Intel® i3®/i5®/i7® processors, Intel Xeon® processor, or any implementation of an ARM® processor. In addition, the processor may be any conventional special purpose processor, including OMAP processors, Qualcomm® processors such as Snapdragon®, or a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. The description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be written in any conventional programming language such as C#, C, C++, BASIC, Pascal, or Java, and run under a conventional operating system. C#, C, C++, BASIC, Pascal, Java, and FORTRAN are industry standard programming languages for which many commercial compilers can be used to create executable code. The system may also be written using interpreted languages such as Pert Python or Ruby. These are examples only and not intended to be limiting.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a, computer-readable medium. Computer-readable media include both computer storage media and communication media including any medium that facilitates transfer of a computer program from one place to another. However, a computer readable storage medium is not a carrier wave, and may be any available media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.) It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments will be apparent to those skilled in the art. The various aspects and embodiments disclosed herein are for purposes of illustration and are not intended to be limiting.

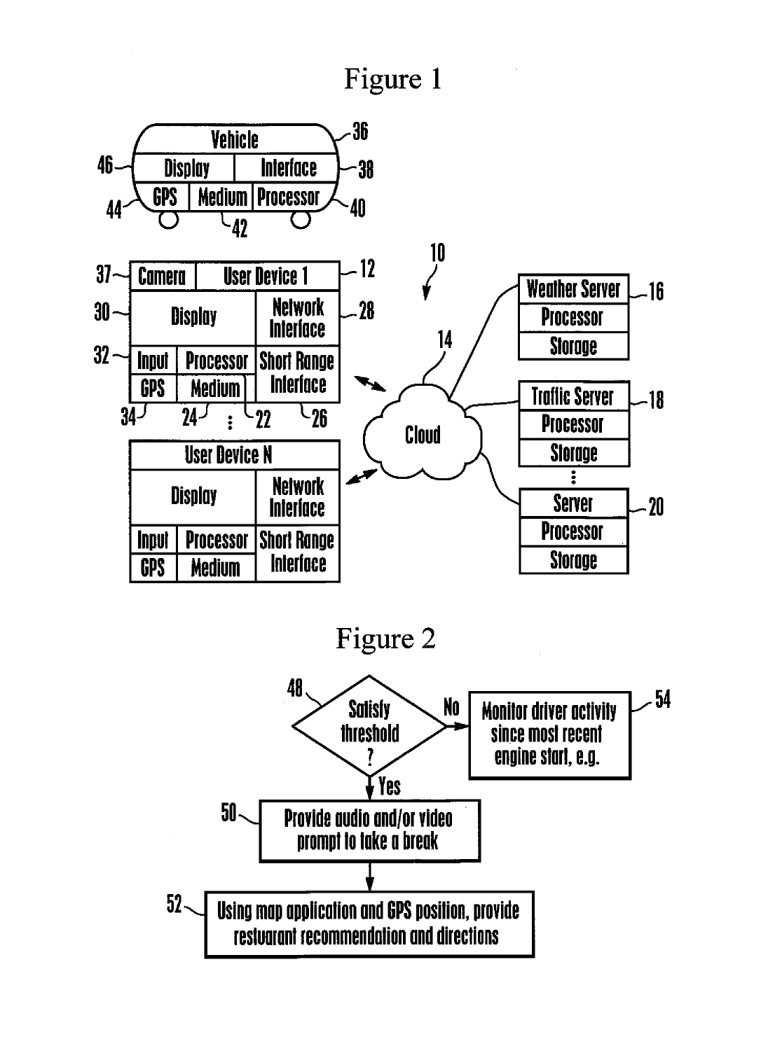

Referring initially to FIG. 1, a system 10 includes at least one and in the example shown “N” user or client devices 12 communicating via a computer cloud 14 such as the Internet with one or more server computers. In the example shown, a weather server 16, a traffic server 18, and in general one or more servers 20 communicate with the client device 12 through the cloud.

Among the non-limiting and example components a client device 12 may incorporate, a processor 22 accesses a computer readable storage medium 24 that contains instructions which when executed by the processor configure the processor to undertake principles disclosed below. The client device 12 may communicate with other client devices using a wireless short range communication interface 26 such as but not limited to a Bluetooth transceiver controlled by the processor 22. Also, the client device 12 may communicate with the cloud 14 using a wireless network interface 28 such as but not limited to one or more of a WiFi transceiver, wireless modem, wireless telephony transceiver, etc. controlled by the processor 22. Wired interfaces 26, 28 are also contemplated.

The client device typically includes a visual display 30 such as a liquid crystal display (LCD) or light emitting diode (LED) display or other type of display controlled by the processor 22 to present demanded images. The display 30 may be a touch screen display. In addition, one or more input devices 32 may be provided for inputting user commands to the processor 22. Example input devices include keypads and keyboards, point-and-click devices, a microphone inputting voice commands to a voice recognition engine executed by the processor 22, etc. A position sensor 34 may input signals to the processor 22 representing a location of the client device 12. While FIG. 1 assumes that the position receiver 34 is a global positioning satellite (GPS) receiver, other position sensors may be used in addition or in lieu of a GPS receiver. For example, a motion sensor 35 such as an accelerometer, gyroscope, magnetic sensor, and the like may be used to input position information to the processor 22. Location information may also be derived from WiFi information, e.g., the location of the client device may be inferred to be the location of a WiFi hotspot in which the device is communicating. Also, a camera 37 may provide image signals to the processor 22.

FIG. 1 also shows that a person carrying the client device 12 may decide to enter a vehicle 36. The vehicle 36 may include a communication interface 38 controlled by a vehicle processor 40 accessing a computer readable storage medium 42. The interface 38 may be configured to communicate with one of the interfaces of the client device 12 and may be a Bluetooth transceiver. The vehicle 36 may include an onboard GPS receiver 44 or other position receiver sending signals to the processor 40 representing the location of the vehicle 36. The vehicle processor 40 may control a visual display 46 in the vehicle to, e.g., present an electronic map thereon and other user interfaces. Other client devices may be transported by their users into other vehicles and establish communication with the processors of the other vehicles.

FIG. 2 shows overall logic that may be executed by the client processor 22 accessing the vehicle processor 42 and/or by the vehicle processor 42 itself. Determination by the client processor 22 and/or vehicle processor 42 that the threshold has been satisfied at decision diamond 48 directs the respective processor 22/42 to provide an audio or video prompt for the driver to take a break at block 50 and to provide a restaurant recommendation with directions using a map application and respective GPS position receiver 34/44 at block 52. The client processor 22 may provide the video prompt on client device display 30 whereas the vehicle processor 42 may provide the video prompt on vehicle display 46. If the client device 12 is a smart agent, an audio notification may be given in the form of a “ding” tone and the driver may interact with the smart agent via touch screen and/or voice.

Determination by the client processor 22 and/or vehicle processor 42 that the threshold has not been satisfied at decision diamond 48 directs the respective processor 22/42 to monitor the driver activity based on preset parameters, e.g. time since most recent engine start at block 54. The processor 22/42 may continuously repeat the cycle beginning at decision diamond 48 until the threshold has been determined to have been satisfied.

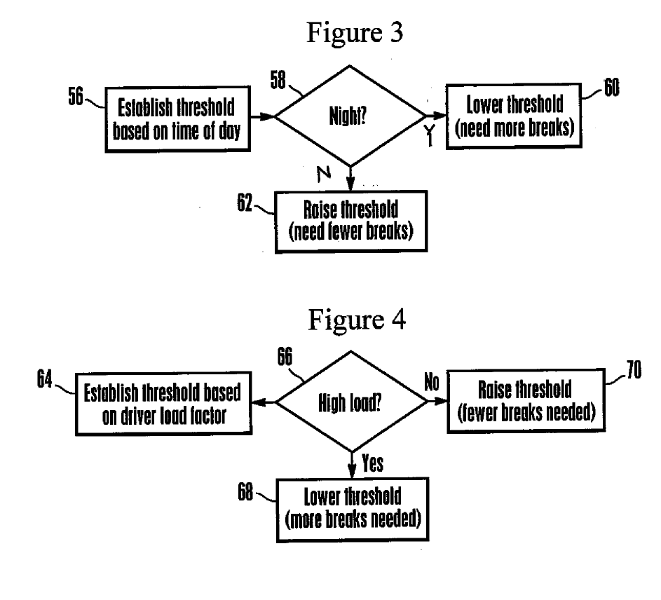

FIG. 3 shows example threshold variation logic based on time of day that may be established and executed by the client processor 22 accessing the vehicle processor 42 and/or by the vehicle processor 42 itself. The threshold can be established based on the time of day at block 56. For example, so that the driver may avoid prolonged driving at night the threshold can be established to be lower at night than it is during the day, resulting in the processor 22/42 executing logic to more frequently (compared to daytime notices) notify the driver that a break is recommended as described in FIG. 2. The client processor 22 or vehicle processor 42 may be in communication with the weather server 16 and obtain information regarding daily sunset times and use that information to determine at any given whether the time of day is nighttime at decision diamond 58.

The threshold may be lowered at block 60, giving the driver more frequent notification that a break is recommended, if the determination that it is nighttime at decision diamond 58. Alternatively, the threshold may be raised at block 62, giving the driver less frequent notifications that a break is recommended, if the determination that it is daytime at decision diamond 58. The frequency with which break notifications are given may be based on parameters such as time driving (elapsed time since engine was last sensed as being turned on by the vehicle engine control module) or distance traveled.

FIG. 4 shows example threshold variation logic based on driver activity load factor that may be established and executed by the client processor 22 accessing the vehicle processor 42 and/or by the vehicle processor 42 itself. The threshold may be established based on driver load factor at block 64 and the client processor 22 or vehicle processor 42 may determine whether the current driver load factors are deemed to be a high load on the driver at decision diamond 66. Determination that current driver load factors correlate to a high load cause the processor 42/22 to lower the threshold, giving the driver more frequent notifications that a break is recommended, at block 68. The threshold may be raised at block 70, reducing the frequency with which breaks are recommended, if the current driver load factors are determined to not correlate to a high load at decision diamond 66.

Driver load factors may include, but are not limited to, one or more of vehicle turns, vehicle brake applications, vehicle speed, and/or vehicle gear shifts. For example, a set number of brake applications and average speed or top speed parameters may define a threshold, normalized for unit time if desired. The processor 42 may determine the number of brake applications and average speed continuously since the point in time at which the engine was last sensed as being turned on by the engine control module.

The driver load factors during a period of driving time may contribute to the threshold in combination with distance traveled, total time driving since last break, proximity to highway rest stop, restaurant, or hotel, and gas tank level. The duration of previous rest breaks taken by the driver may also contribute to the establishment, raising, or lowering of the threshold. The client processor 22 and vehicle processor 42 may communicate with each other as well as with sources such as the GPS positioning receiver 34/44 or weather server 16 to automatically collect data that determine any of the factors contributing to the establishment, raising, or lowering of the threshold. Furthermore, the threshold may be determined by any combination of factors or by one particular factor, e.g. gas tank level.

In addition to the above, a driver may use a wearable sensor on, e.g., a wristwatch to send biometric data to the client processor 22 using, e.g., Bluetooth. This biometric data, e.g., heart rate, temperature, and the like can be compared against benchmarks to determine if the driver is in a physical state (for example, may be getting sleepy as indicated by decreasing pulse rate or decreasing brain activity) that triggers an immediate alarm as discussed above, instead of waiting for a period to expire.

Also, time of day and previous user behavior may be used to determine the normal eating patterns of a particular user and to suggest a break based on past restaurant stops at similar times of day. Still further, a passenger(s) can be detected using, e.g., presence signals from multiple client devices or seatbelt latch information sent from the ECM or other means to alter the above recommendations based proximity to others. Example passenger detection methods can be implemented by either car sensors (door open, window open by user buttons, airbag weight sensor) or mobile radio communication on cellular, tablet (wifi 3G radios).

While the particular METHOD AND APPARATUS FOR AUTOMATICALLY WARNING DRIVER TO TAKE A BREAK is herein shown and described in detail, it is to be understood that the subject matter which is encompassed by the present invention is limited only by the claims.

What is claimed is:

1. Apparatus comprising:
at least one computer readable storage medium that is not a carrier wave and that is accessible to a client processor and bearing instructions which when executed by the client processor configure the client processor to execute logic to execute a method comprising:
establishing communication with a vehicle processor;
determining a driver activity parameter of a driver of a vehicle associated with the vehicle processor;
responsive to a determination that the driver activity parameter satisfies a threshold, presenting on a display in the vehicle a prompt for a driver of the vehicle to stop for a break, and/or presenting on a display in the vehicle a recommendation of a restaurant along with directions to the restaurant.

2. The apparatus of claim 1, wherein the instructions when executed by the client processor cause the client processor to:
responsive to a determination that the driver activity parameter satisfies a threshold, presenting on a display in the vehicle a prompt for a driver of the vehicle to stop for a break.

3. The apparatus of claim 1, wherein the instructions when executed by the client processor cause the client processor to:
responsive to a determination that the driver activity parameter satisfies a threshold, presenting on a display in the vehicle a recommendation of a restaurant along with directions to the restaurant.

4. The apparatus of claim 1, wherein the instructions when executed by the client processor cause the client processor to:
establish the threshold at least in part based on time of day such that a first threshold is used at a first time of day and a second threshold is used at a second time of day.

5. The apparatus of claim 1, wherein the instructions when executed by the client processor cause the client processor to:
establish the threshold at least in part based on driver activity load factor such that a first threshold is used for a first driver activity load factor and a second threshold is used for a second driver activity load factor.

6. The apparatus of claim 5, wherein the driver activity load factor includes one or more of vehicle turns, vehicle brake applications, vehicle speed, vehicle gear shifts.

7. The apparatus of claim 1, wherein the instructions when executed by the client processor cause the client processor to:
establish the driver activity parameter based on a number of vehicle turns, the threshold being a threshold number of vehicle turns.

8. The apparatus of claim 1, wherein the instructions when executed by the client processor cause the client processor to:
establish the driver activity parameter based on a number brake applications by the driver, the threshold being a threshold number of brake applications.

9. The apparatus of claim 1, wherein the instructions when executed by the client processor cause the client processor to:
establish the driver activity parameter based on a speed of the vehicle, the threshold being a threshold average or top speed for a threshold period.

10. The apparatus of claim 1, wherein the instructions when executed by the client processor cause the client processor to:
establish the driver activity parameter based on a number of gear shifts of the vehicle by the driver the threshold being a threshold number of gear shifts.

11. The apparatus of claim 1, wherein the instructions when executed by the client processor cause the client processor to:
establish the driver activity parameter based on a distance traveled, and the threshold is a threshold distance.

12. Apparatus comprising:
at least one computer readable storage medium that is not a carrier wave and that is accessible to a processor and bearing instructions which when executed by the client processor configure the processor to execute logic to execute a method comprising:
determining a driver activity parameter of a driver of a vehicle associated with the vehicle processor;
responsive to a determination that the driver activity parameter satisfies a threshold, presenting on a display in the vehicle a prompt for a driver of the vehicle to stop for a break, and/or presenting on a display in the vehicle a recommendation of a restaurant along with directions to the restaurant.

13. The apparatus of claim 12, wherein the instructions when executed by the client processor cause the client processor to:
responsive to a determination that the driver activity parameter satisfies a threshold, presenting on a display in the vehicle a prompt for a driver of the vehicle to stop for a break.

14. The apparatus of claim 12, wherein the instructions when executed by the client processor cause the client processor to:
responsive to a determination that the driver activity parameter satisfies a threshold, presenting on a display in the vehicle a recommendation of a restaurant along with directions to the restaurant.

15. The apparatus of claim 12, wherein the instructions when executed by the client processor cause the client processor to:
establish the threshold at least in part based on time of day such that a first threshold is used at a first time of day and a second threshold is used at a second time of day.

16. The apparatus of claim 12, wherein the instructions when executed by the client processor cause the client processor to:
establish the threshold at least in part based on driver activity load factor such that a first threshold is used for a first driver activity load factor and a second threshold is used for a second driver activity load factor.

17. The apparatus of claim 16, wherein the driver activity load factor includes one or more of vehicle turns, vehicle brake applications, vehicle speed, vehicle gear shifts.

18. The apparatus of claim 12, wherein the instructions when executed by the client processor cause the client processor to:
establish the driver activity parameter based on a driver activity load factor.

19. Method comprising:
establishing a driver caution threshold that varies by time of day and/or by driver activity load factor;
comparing a vehicle driver's activity to the driver caution threshold;
responsive to a determination that vehicle driver's activity violates the driver caution threshold, presenting a prompt to take a break and/or presenting directions to a nearby restaurant; and
responsive to a determination that vehicle driver's activity does not violate the driver caution threshold, not presenting a prompt to take a break and/or not presenting directions to a nearby restaurant.

20. The method of claim 19, comprising:
responsive to a determination that vehicle driver's activity violates the driver caution threshold, presenting directions to a nearby restaurant.
